(19) United States
(12) Patent Application Publication
(10) Pub. No.: US 2003/0012890 A1
(43) Pub. Date: Jan. 16, 2003

(54) METHOD FOR PRODUCING A PLASMA BY MICROWAVE IRRADIATION

(76) Inventors: THOMAS WEBER, KORNTAL-MUENCHINGEN (DE); JOHANNES VOIGT, LEONBERG (DE); SUSANNE LUCAS, STUTTGART (DE)

Correspondence Address: KENYON & KENYON, ONE BROADWAY, NEW YORK, NY, 10004, US

(21) Appl. No.: 09/508,971

(22) PCT Filed: Sep. 15, 1998
(86) PCT No.: PCT/DE98/02727

(30) Foreign Application Priority Data
Sep. 17, 1997 (DE) 197 40 792.7

(51) Int. Cl. H05H 1/24

(52) U.S. Cl. 427/569

(57) ABSTRACT

The invention relates to a method for producing a plasma through irradiation by microwaves, a process gas being directed into a receiver and a plasma being ignited by microwave irradiation. According to the invention, the coupled-in microwave radiation is pulsed. In this manner, it is possible to reduce the effective microwave power, accompanied by the same process result, thus permitting the process temperature to be lowered. Furthermore, when working with effectively identical coupled-in power, it is possible to increase the process rate, which means the process time can be reduced and the method can be high-scaled to large batch quantities.

### BACKGROUND INFORMATION

The invention relates to a method for producing a plasma through irradiation by microwaves, a process gas being directed into a receiver, a microwave radiation being generated by a radiation source, and this microwave radiation being irradiated into the receiver, so that a plasma is ignited.

Processes in which microwave radiation is generated and used to ignite a plasma are known and employed in the most varied fields. They can be independent processes, or a part of a sequence of different processes. The plasma produced by the microwave radiation can also be used for igniting a further plasma.

An important application field is the treating of surfaces. To be understood by this are both coating and non-coating processes, e.g., eroding or activating processes. Of the coating processes, the coating of plastics and hardened steels with a hard wearing-protection coat are of particular importance. For example, such a wearing-protection coat can be a hard, amorphous carbon coating (a-C:H).

Processes of this type are known from DE 195 13 614, U.S. Pat. No. 5,427,827 and U.S. Pat. No. 4,869,923. DE 195 13 614 describes the deposition of carbon films using applied bipolar-pulsed bias. U.S. Pat. No. 5,427,827 deals with the deposition of visually transparent, diamond-like carbon films in the continuous microwave ECR plasma at a substrate temperature of 50° C., a sinusoidal RF alternating voltage being applied. A so-called downstream process is described, in which the plasma is produced and the film is deposited spatially separately in two chambers. The U.S. Pat. No. 4,869,923 relates to a process in which a plasma is generated through continuous irradiation by microwaves, however without bipolar-pulsed bias.

Disadvantageous in these known processes is that, to deposit hard films several μm thick at high deposition rates, the typical process temperatures lie at approximately 180-220° C. These high temperatures can cause a loss of hardness in the substrate. The coating of plastic substrates is not easily possible with this method, since the plastic softens because of the temperature stress, so that the substrates change their shape. It may be that relief can be provided by reducing the irradiated microwave power. However, because of this, the coating rate is also reduced, so that in turn, the process time is extended. Another corrective possibility is to insert pause times between the bipolar substrate pulses for accelerating the ions. However, this leads to a reduction in the deposition rate and, what is much more serious, a reduction in the hardness of the film.

In another known method, both the production of the plasma and the acceleration of the ions onto the substrates are effected jointly by a high-frequency sinusoidal alternating voltage at the substrates. In this case, the process temperature lies at approximately 15° C. The disadvantage in this method, however, is that for technical reasons, scaling to large batch quantities such as the industrially customary batch sizes is not easily possible.

### ADVANTAGES OF THE INVENTION

In contrast, the method of the present invention, in which a pulsed microwave radiation is used for producing the plasma, has the advantage that the process temperature can be set to less than 200° C., and scaling to large batch quantities is possible. Thus, the method according to the invention is particularly suitable for the treatment of temperature-sensitive substrates and for the processing of industrially customary batch sizes.

The reduction of the process temperature is made possible because, given the same process result, the coupled-in power of the pulsed microwave radiation can be lowered compared to the necessary power of the unpulsed microwave radiation. The method of the present invention is based on the finding that the ion current density, which is extractable from a plasma produced by microwave radiation and which can act upon the substrates, increases disproportionally with respect to the coupled-in power of the microwave radiation. Thus, if the power of the coupled-in microwave radiation is doubled, then the ion current increases as well, but by more than the double. Therefore, in the related art, the power of the continuous microwave radiation is lowered until the desired ion current density is reached. In the method of the present invention, one starts instead from a high power of the microwave radiation and ignites the plasma by a pulsed excitation. For example, if the original power of the microwave radiation is doubled and a pulse frequency is selected at which the microwave generator is in the “on” operating state for 50% of the operating time and is in the “off” operating state for 50%, then the originally doubled power is effectively halved. This halving of the “duty cycle” from 100% to 50% results in a halving of the ion current. However, due to the doubling carried out in the beginning, the initial value of the ion current was already increased compared to the unpulsed case, and specifically to more than the double.

Thus, given the same effective microwave power, it is possible to achieve a greater effect, in this case, a higher ion current. Consequently, to obtain the originally desired ion current again, the operating time of the microwave generator must be reduced even further. With that, however, the effective power of the microwave radiation is dropped below the source value. Therefore, the same effect is achieved, namely, the same ion current, when working with reduced effective power of the microwave radiation.

The reduction of the effective power of the microwave radiation, accompanied by the same process result, leads to a lowering of the process temperature. Thus, the method of the present invention is particularly well-suited for treating temperature-sensitive substrates. On the other hand, the process rate is increased when working with effectively identical coupled-in power of the microwave radiation. Consequently, the process time is reduced. The method thus becomes faster and cheaper, and can therefore be scaled to large batch quantities.

When working with low powers of the microwave radiation (e.g., approximately 0.5 kW), one also observes a stabilization of the plasma as is not possible in the previously known methods. A non-pulsed plasma can generally not be energized stably below a certain power; it extinguishes. In contrast, in the method of the present invention, with the aid of pulsing, a continuous operation below this limiting value is possible even with low microwave powers.

The measures indicated in the subclaims permit advantageous further developments and improvements of the method stated in claim 1.

Naturally, the method of the present invention can be used in all microwave-supported processes. It can be an independent process. However, it can also be part of a sequence of various processes. The processes can be those for surface treatment, and can be coating or non-coating processes. In the case of the non-coating processes, differentiation is made between eroding and non-eroding, e.g., activating processes.

The microwave radiation can be combined with other sources for particles, electromagnetic radiation or particle radiation, e.g., sputtering sources, vaporization sources or arc sources.

Depending on the process in which it is used, the microwave plasma itself can be utilized in various ways, e.g., as a plasma source or as an ion source. These ions can be accelerated by a negative substrate voltage onto the substrates.

However, the microwave plasma can also be employed as an ignition aid for other plasmas.

Drawing

In the following, the invention is explained in more detail on the basis of an exemplary embodiment with reference to the Drawing, in which:

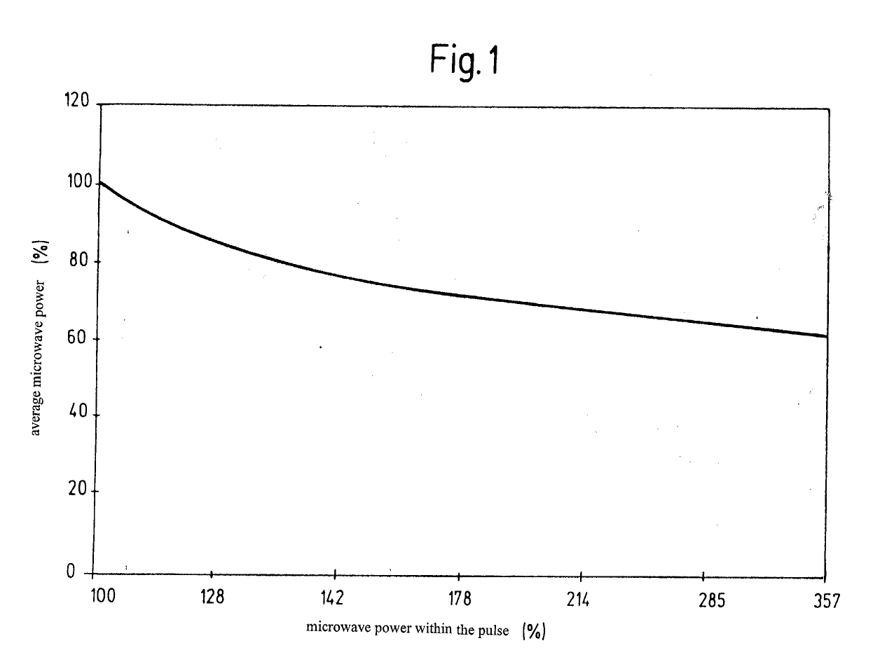

FIG. 1 shows a graphic representation of the dependence of the average power of the microwave radiation on the power per microwave pulse for a constant average ion current on the substrates;

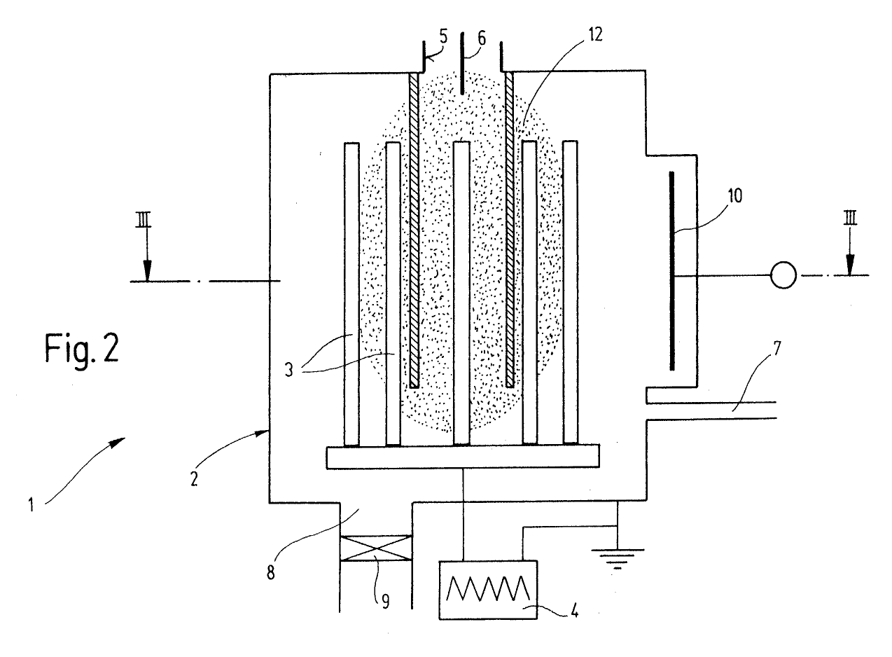

FIG. 2 shows a schematic representation of a device for implementing the method of the present invention;

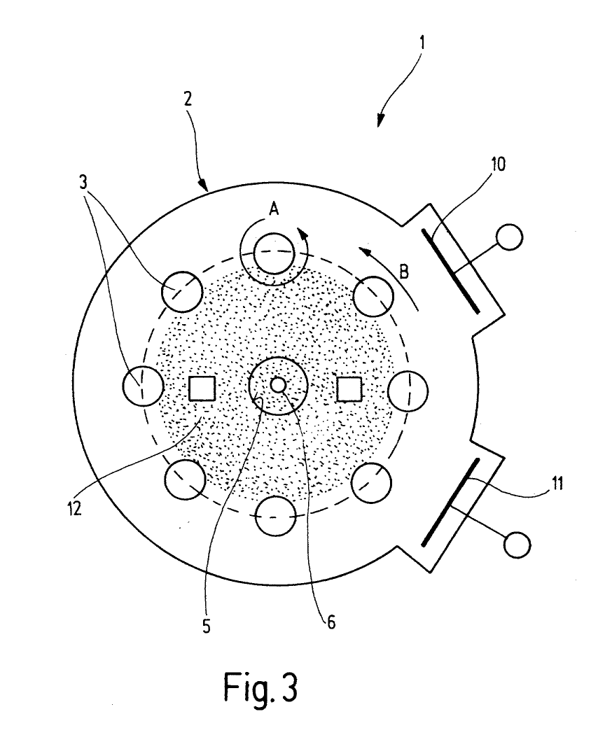

FIG. 3 shows a section along Line III-III in FIG. 2.

FIG. 1 illustrates again how the effective power of the microwave radiation is reduced by the method of the present invention, accompanied by the same process result. In this case, a microwave plasma was produced with a microwave radiation having a power of 0.84 kW, using argon as the process gas at a pressure of p=1×10³ mbar. The substrate ion current was measured by applying a negative biassupply to substrates located in the plasma. The initial state corresponds to 100% of the unpulsed microwave power, i.e., during the operating time of the radiation source, it was exclusively in the “on” operating state. This corresponds to a “duty cycle” of 1 (100%). The microwave power was now systematically increased. The ion current, likewise rising with it, was reduced by pulsing the microwave radiation. Thus, the power of the microwave radiation remains high within the pulse. However, the radiation source is no longer continuously in the “on” operating state, but rather is in the “off” operating state for a time. This corresponds to a “duty cycle” below 1 (less than 100%). The effective power of the microwave radiation is calculated from the radiation power per pulse multiplied by the value for the duty cycle. This is adjusted in such a way that the ion current density, thus the bias current at the substrates, is reduced to the initial value and is held constant. It can be seen from the plotting that, given an increase of the pulse power, a reduction of the effective microwave power is possible, accompanied by the same effect.

FIGS. 2 and 3 show schematically a device 1 for implementing the method of the present invention. Device 1 includes a receiver 2 having a circular cross-section with a diameter of approximately 70 cm. Substrates 3 are placed in receiver 2. In this case, they are steel substrates. In the present case, provision is made for doubly rotating substrates 3 which rotate in the direction of arrows A and B in FIG. 3, both about themselves and about the midpoint of receiver 2. Substrates 3 are connected to a voltage source 4, so that a negative bias supply can be applied, which can also be pulsed.

Receiver 2 has an opening 5 through which a microwave radiation generated by a voltage source 6 can be coupled in. Provision is also made for a short feed pipe 7 for passing the process gas in, and a short suction pipe 8 with regulating valve 9 for the application of the necessary underpressure. In addition, receiver 2 has two further radiation sources 10 and 11, in the present case, two sputter cathodes.

The method according to the invention was carried out as follows:

First of all, a plasma cleaning of the substrates was carried out in a known manner, in that an Ar-plasma was ignited in response to negative voltage applied to the substrates. This is used for cleaning and to increase the adhesion of the coating to be subsequently applied.

As a next step, using a known method, a metallic layer is applied which increases the adhesion of the functional layer to be subsequently applied.

The functional layer is deposited in the following manner: acetylene was fed as a process gas into receiver 2 via short feed pipe 7. The pressure was set at 3×10⁻³ mbar. A microwave radiation with a power of 1.1 kW

(=100% unpulsed power) was coupled in, so that a plasma 12 ignited. For the pulsing, the power of the microwave radiation was increased to 110%, and the pulse frequency was set at 5 kHz. The “duty cycle” of radiation source 6 was 50%, i.e., during the entire operating time, voltage source 6 was in the “on” operating state for 50%.

A bipolar bias voltage was applied to the substrates. The average value of the substrate voltage over time was −200V.

In the exemplary embodiment, receiver 1 is coupled to two sputter sources 10, 11. In this manner, in addition to the coating process, a sputtering process can be utilized. Coupling to other sources of electromagnetic or particle radiation such as vaporization sources and arc sources is also conceivable.

The temperature of the unpulsed process (unpulsed radiation with a power of 1.1 kW) was approximately 220° C. After the pulsing, a reduction of the temperature to below 200° C. was observed. In the pulsed and in the unpulsed process, amorphous carbon films (a-C:H) were deposited with comparable rates and, within the scope of measuring accuracy, identical hardness and tribological properties. The properties of the layers produced were:

amorphous, hydrogenous carbon layer (a-C:H) with metallic adhesion layer

layer thickness 2-3 μm

layer hardness 2000-4000 HV

coefficient of friction vis-a-vis steel 0.1

The exemplary embodiment described above can be varied in diverse manner. A combination of the pulsed plasma generation with a substrate voltage supply is advantageous. This permits the separate plasma generation and acceleration of charged particles onto the substrate, and thus the selective influencing of layer properties. Conceivable as the substrate voltage supply are:

d.c. voltage supply

alternate frequency, particularly for electrically insulating layers.

The frequency of the alternate frequency can be less than, equal to or greater than the frequency of the microwave. In the case of frequency equality, it may be advantageous to adjust the phase between bias pulse and microwave pulse in a defined manner.

To be considered as alternate frequency are, for instance, a sinusoidal time-related voltage characteristic, a pulse-like monopolar voltage and a pulse-like bipolar voltage with or without intervals between the individual voltage pulses.

The microwave frequency can lie within the industry frequency range, for example, at 2.45 GHz, 1.225 GHz and 950 MHz GHz. Pulse frequencies are conceivable, for example, which reach into the megahertz range. At the moment, frequencies of 0.1 to 100 kHz are preferred for technical reasons, it being possible to achieve a frequency spectrum of 2-10 kHz particularly easily without great expenditure for apparatus.

Depending upon the use, it is possible to intensify the useful effect of the pulsing with the microwave power. The upper limit of the power of the microwave radiation is equal to the power limit of the radiation source employed. A lower limit of 0.5 kW is recommendable. Values over 1 kW and over 3 kW, respectively, are especially preferred.

Various types of microwave plasmas can find use. First of all, pure microwave plasmas can be used in a pressure range >10⁻² mbar, or with additional magnetic field as ECR microwave plasma in a pressure range >10⁻⁴ mbar.

The method of the present invention is suitable for all types of coating microwave plasmas. For example, methane and acetylene can be used as process gases for coating with C-containing films. Silanes, e.g., silane or silicon-organic compounds such as HMDS, HMDS(O), HMDS(N) or TMS are suitable as process gases for producing silicon-containing films. However, other process gases familiar to one skilled in the art, such as metallo-organic compounds, are also usable. The method is also suitable for the deposition of plasma polymer layers. The deposition of layer systems through a combination of different gases is likewise possible.

It is possible to combine the layer, to be deposited according to the method described, with other layers, particularly those which are deposited according to known methods. For example, the combination can be effected in multi-layers.

The process gas can also be exchanged during the interpulse periods, so that each plasma pulse begins with fresh process gas. This can be important for the treating and coating of substrates having complex geometric proportions.

The substrates can be stationary, rotating or moving linearly. Of course, the method can be carried out in other types of installations, such as in batch installations or continuous installations or bulk-material installations.

The method of the present invention is further suitable for non-coating processes to activate surfaces, for plasma fine-cleaning of surfaces or for the plasma structuring of surfaces. It advantageously permits lower treatment temperatures or a quicker process, i.e., shortening of the process time, in these cases as well.

1. A method for producing a plasma through irradiation by microwaves, a process gas being directed into a receiver, a microwave radiation being generated by a radiation source, and this microwave radiation being irradiated into the receiver, so that a plasma is ignited,
characterized in that a pulsed microwave radiation is used for igniting and for energizing the plasma.

2. The method as recited in claim 1,
characterized in that a microwave radiation with a pulse frequency of at least approximately 0.1 kHz, preferably
1 kHz-10 kHz, is used.

3. The method as recited in one of the preceding claims,
characterized in that the effective operating time (duty cycle) of the radiation source is freely selectable, preferably set to 30-70% of the process time.

4. The method as recited in one of the preceding claims,
characterized in that quantities averaged over time, such as the substrate ion current or the coating rate for the pulsed process (duty cycle <100%) are quantities equal to those in the unpulsed process (duty cycle 100%), when working with microwave power reduced when averaged over time.

5. The method as recited in one of claims 1 through 3,
characterized in that quantities averaged over time, such as the substrate ion current or the coating rate for the pulsed process (duty cycle <100%), are greater than the quantities in the unpulsed process (duty cycle 100%), when working with microwave power equal when averaged over time.

6. The method as recited in one of the preceding claims,
characterized in that the process gas is exchanged during the interpulse periods.

7. The method as recited in one of the preceding claims,
characterized in that a microwave radiation is used having an input power of at least approximately 0.5 kW, particularly more than 1 kW or more than 3 kW.

8. The method as recited in one of the preceding claims,
characterized in that a microwave radiation is used having a frequency in the gigahertz range, preferably 2.45 GHz, 1.225 GHz or 0.95 GHz.

9. The method as recited in one of the preceding claims,
characterized in that the process temperature is set to below 200° C.

10. The method as recited in one of the preceding claims,
characterized in that the plasma is formed as ECR plasma at low pressures.

11. The method as recited in one of the preceding claims,
characterized in that the plasma is used as a plasma source or as an ion source.

12. The method as recited in claim 11,
characterized in that it is used in processes for treating and coating surfaces of substrates.

13. The method as recited in claim 12,
characterized in that it is used for producing coating plasmas.

14. The method as recited in claim 12,
characterized in that it is used for non-coating processes in order to activate surfaces.

15. The method as recited in one of the preceding claims,
characterized in that one of the following layers is deposited:
carbon-containing layers, particularly amorphous, hydrogenous carbon a-C:H;
silicon-containing layers, particularly amorphous, hydrogenous silicon a-Si:H; or
plasma polymer layers.

16. The method as recited in claim 12,
characterized in that it is used in processes for eroding surface treatment, particularly plasma fine-cleaning and/or plasma structuring of surfaces.

17. The method as recited in one of claims 12 through 16,
characterized in that the parts to be treated or to be coated are connected to a bias potential, preferably a negative bias potential.

18. The method as recited in claim 17,
characterized in that the bias is pulsed—particularly monopolar-pulsed bias, bipolar-pulsed bias, in particular with or without time intervals between the pulses.

19. The method as recited in claim 17,
characterized in that a high-frequency bias, particularly in the kHz or MHz range is used.

20. The method as recited in one of the preceding claims,
characterized in that the microwave radiation is combined with other sources for particles, electromagnetic radiation or particle radiation.

21. The method as recited in one of claims 1 through 11,
characterized in that the plasma is used for igniting a further plasma.

22. The method as recited in one of the preceding claims,
characterized in that the coating is carried out on stationary or moving substrates.

23. Use of the method as recited in one of claims 1 through 22 in a batch installation or a continuous installation or a bulk-material installation.
